(19) United States
(12) Patent Application Publication
(10) Pub. No.: US 2021/0166260 A1
(43) Pub. Date: Jun. 3, 2021

(54) SYSTEMS AND METHODS FOR PROVIDING A MERCHANT OFFER

(71) Applicant: Wells Fargo Bank, N.A., San Francisco, CA (US)

(72) Inventors: Peter Ho, San Francisco, CA (US); Sarah Welch Phelps, San Francisco, CA (US)

(21) Appl. No.: 14/256,455

(22) Filed: Apr. 18, 2014

(51) Int. Cl. G06Q 30/02

(52) U.S. Cl. CPC G06Q 30/0233; G06Q 30/0238

(57) ABSTRACT

A computer system includes a processor coupled to machine-readable storage media. The processor is configured to receive a request from a mobile device of a user to initiate a transaction at a point of sale location between the user and a merchant, receive a user selection of a selectable payment option for the transaction, wherein the selectable payment option includes a user rewards redemption, apply a merchant offer to the transaction, generate a code that is displayable on the mobile device, including embedding in the code one or more details related to the transaction, send the code to one of the user at the mobile device or the merchant at a merchant point of sale device for the other of the user or the merchant to scan at the point of sale location, receive the code, and update a user rewards account associated with the user based on the transaction.

### BACKGROUND

Banking entities or other financial institutions often provide credit or debit cards to account holders to allow the account holders to make purchases using the cards. A card issuing entity will often receive a commission from a merchant when one of the cards is used in a transaction with the merchant. In order to encourage its customers to use such cards more frequently and thus generate more revenue, the card issuing entity may offer incentives for each purchase the customer makes using the card. Such incentives may be provided in the form of a loyalty or rewards program associated with a particular card. For example, a card issuer may offer a cashback reward program where a percentage of the amount of each purchase using the associated card is credited back to the customer as a monetary amount. Similarly, the card issuer may credit the customer with a certain number of rewards points based on the amount of each purchase using the associated card. The rewards points earned by the customer may be redeemed for a variety of goods, services, and other items. For example, the card issuer may allow its customers to redeem points for gift cards, travel, online digital media, merchandise, or cash.

While many card issuing entities offer a wide variety of options for which points may be redeemed, there are currently many limitations on the manner in which rewards points may be redeemed by the customer. For example, many rewards programs that allow customers to redeem rewards points for cash do not allow customers to directly redeem their rewards points in merchant point of sale transactions. Rather, the card issuers require their customers to manually redeem their rewards points in separate points redemption transactions using a system hosted by the card issuer, and may also require customers to redeem rewards points for predetermined cash amounts after minimum thresholds are met. As a result, it may be difficult for a merchant to provide offers or discounts to an account holder in a transaction involving user rewards. Likewise, it may be difficult for an account holder to take advantage of offers or discounts made available by the merchant at a point of sale location when conducting a transaction involving user rewards.

### SUMMARY

An embodiment of the present disclosure relates to a computer-implemented method. The method includes receiving a request from a mobile device of a user to initiate a transaction at a point of sale location between the user and a merchant, receiving a user selection of a selectable payment option for the transaction, wherein the selectable payment option includes a user rewards redemption, applying a merchant offer to the transaction, generating a code that is displayable on the mobile device, including embedding in the code one or more details related to the transaction, sending the code to one of the user at the mobile device or the merchant at a merchant point of sale device for the other of the user or the merchant to scan at the point of sale location, receiving the code, and updating a user rewards account associated with the user based on the transaction.

Another embodiment of the present disclosure relates to a computer system having a processor coupled to machine-readable storage media. The machine-readable storage media includes instructions stored therein that configure the processor to receive a request from a mobile device of a user to initiate a transaction at a point of sale location between the user and a merchant, receive a user selection of a selectable payment option for the transaction, wherein the selectable payment option includes a user rewards redemption, apply a merchant offer to the transaction, generate a code that is displayable on the mobile device, including embedding in the code one or more details related to the transaction, send the code to one of the user at the mobile device or the merchant at a merchant point of sale device for the other of the user or the merchant to scan at the point of sale location, receive the code, and update a user rewards account associated with the user based on the transaction.

Another embodiment of the present disclosure relates to a computer-implemented method. The method includes receiving, via a mobile device of a user, a request to present one or more selectable user rewards redemption options based on a categorization, displaying, via the mobile device, the one or more selectable user rewards redemption options based on the categorization, receiving, via the mobile device, a user selection from the one or more user rewards redemption options, receiving, via the mobile device, a request to initiate a transaction at a point of sale location between the user and a merchant, wherein the user selection includes a payment method for the transaction, applying a merchant offer to the transaction, and updating a user rewards account associated with the user based on the transaction.

### BRIEF DESCRIPTION OF THE DRAWINGS

FIG. 1A is a block diagram of a computer-implemented user rewards system, according to an exemplary embodiment.

FIG. 1B is a block diagram of a site map for a mobile rewards site, according to an example embodiment.

FIG. 2 is a screen shot of the mobile rewards site prior to providing login information, according to an exemplary embodiment.

FIG. 3 is a screen shot showing an authenticated view of the mobile rewards site, according to an example embodiment.

FIG. 4 is a partial screen shot of the mobile rewards site showing a menu for selecting a rewards ID, according to an example embodiment.

FIG. 5 is a screen shot of the mobile rewards site showing goods and services categories for selecting a user rewards redemption option, according to an example embodiment.

FIG. 6 is a screen shot of the mobile rewards site showing a listing of offers for additional rewards earnings available in the office and electronics merchant category, according to an example embodiment.

FIG. 7 is a partial screen shot of the mobile rewards site showing a menu for filtering offers for additional rewards earnings, according to an example embodiment.

FIG. 8 is a screen shot of the mobile rewards site showing merchants available for selecting offers for additional rewards earnings, according to an example embodiment.

FIG. 9 is a screen shot of the mobile rewards site showing available offers for additional rewards earnings for merchants located near the mobile device, according to an example embodiment.

FIG. 10 is a screen shot of the mobile rewards site showing offers for additional rewards earnings tailored to a preference of the account holder, according to an example embodiment.

FIG. 11 is a screen shot of the mobile rewards site showing details for a merchant value card, according to an example embodiment.

FIG. 12 is a screen shot of the mobile rewards site showing menu options for user rewards, according to an example embodiment.

FIG. 13 is a screen shot of the mobile rewards site showing offers stored within a user rewards account, according to an example embodiment.

FIG. 14 is a screen shot of the mobile rewards site showing details for a merchant offer, according to an example embodiment.

FIG. 15 is a screen shot of the mobile rewards site showing merchant value cards stored within the user rewards account, according to an example embodiment.

FIG. 16 is a screen shot of the mobile rewards site showing information and options for a selected merchant value card, according to an example embodiment.

FIG. 17 is a screen shot of the mobile rewards site showing account details related to the user rewards account, according to an example embodiment.

FIG. 18 is a screen shot of the mobile rewards site showing a preferences menu related to the user rewards account, according to an example embodiment.

FIG. 19 is a screen shot of the mobile rewards site showing a code that may be scanned by a merchant to process a financial transaction, according to an example embodiment.

FIG. 20 is a flow chart diagram of a process implemented by the user rewards system of FIG. 1.

FIG. 21 is a flow chart diagram of another process implemented by the user rewards system of FIG. 1.

### DETAILED DESCRIPTION

According to various example embodiments, a system is provided for using a mobile device to redeem points at a point of sale location and applying a merchant offer or discount at the time of redemption. The system may be used by a customer (e.g., account holder, user, etc.) of a card issuing entity, such as a bank or other financial institution. The card issuing entity may provide rewards programs and accounts in conjunction with credit card accounts, wherein rewards points or other user rewards (e.g., gift cards, discounts, cash, etc.) are earned by the customer for each purchase the customer makes using a card issued by the entity. The rewards points earned by the customer, for instance, may be redeemed for a variety of goods, services, and/or cash. A customer seeking to purchase goods or services from a merchant in a point of sale transaction by redeeming rewards points may access a user rewards account by providing authentication data to a mobile device, such as a cellular phone, smart phone, personal digital assistant (PDA), tablet device, laptop computer or other device, in order to access a mobile rewards site operated by the financial institution. The mobile device may be, for example, a near field communications (NFC) equipped device.

The account management system may be operated by a banking entity that maintains and stores the user rewards account for the customer. The account management system may be used to facilitate a transaction between an account holder and a merchant at a point of sale location using a mobile device of the account holder. The account holder may send a request to the account management system (e.g., the banking entity) to initiate a transaction between the account holder and the merchant. For instance, the account holder may select a user rewards redemption option for use within the transaction. The banking entity may then generate a code with the payment amount and other information embedded, and then send the code to the mobile device or the merchant for the other to read (e.g., scan) and send back to the banking entity (e.g., to verify the transaction). A merchant offer, such as a discount, may be accepted by the account holder (e.g., via the mobile device) and applied at the time of the transaction.

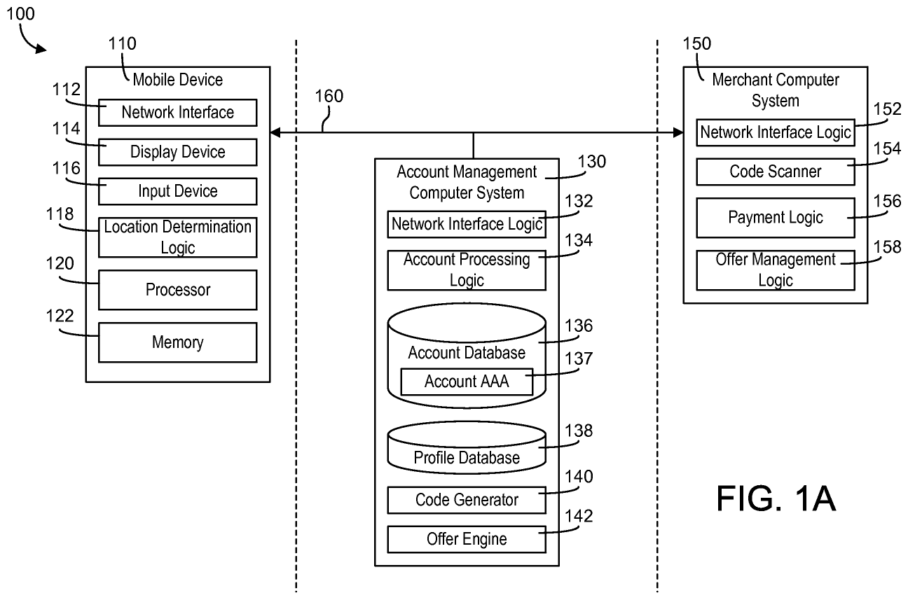

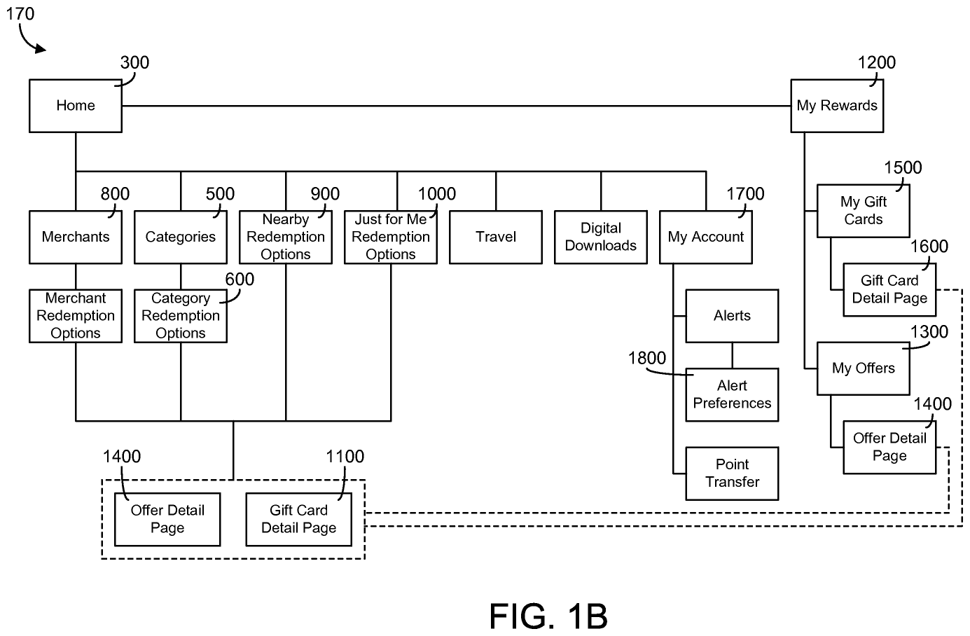

Referring to FIG. 1A, a computer-implemented user rewards redemption system 100 is shown, according to an exemplary embodiment. User rewards system 100 may be utilized by a user or account holder to set up and manage a user rewards account 137, as well as to manage user rewards stored within the account 137. The user may be a business entity and/or an individual customer that has one or more financial accounts (e.g., credit card accounts, checking accounts, savings accounts, investment accounts, etc.) with a financial institution. The financial accounts may include business or personal accounts. The user rewards account 137 may be stored within an account management computer system 130. The account management computer system 130 may be managed or otherwise provided by a financial institution managing one or more financial accounts of the user. The user rewards account 137 may be established, for example, through an online banking area of a web site of the financial institution that operates the account management computer system 130 and that maintains the user rewards account 137. The user rewards account 137 can be created for the user to earn rewards points and other user rewards, and also to redeem the rewards points in exchange for goods and services from a merchant. In some embodiments, funds may also be stored within the account management computer system 130 (e.g., within the user rewards account 137) and transferred to a merchant or another user.

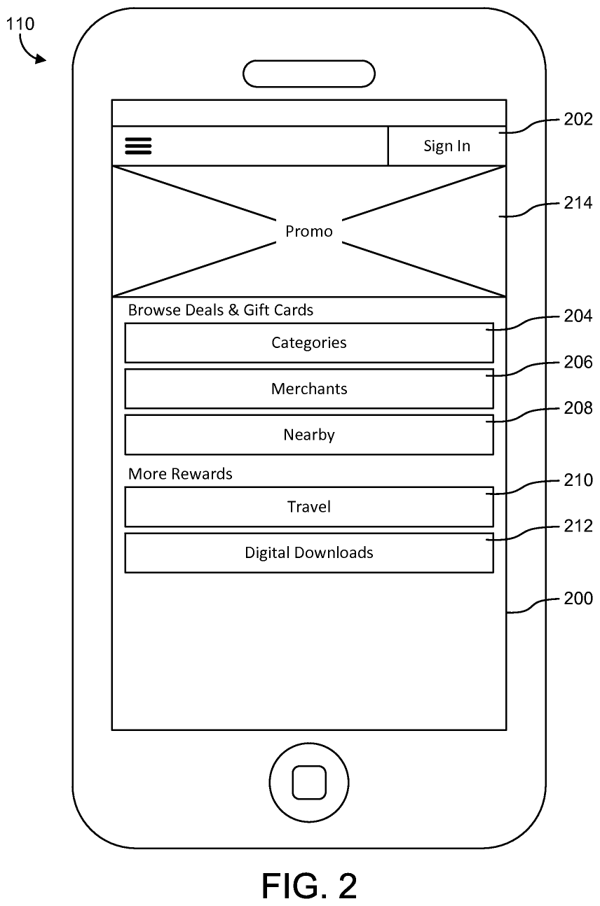

User rewards system 100 may include, among other systems, mobile device 110, account management computer system 130, and a merchant computer system 150. The mobile device 110, the account management computer system 130, and the merchant computer system 150 may communicate through a network 160, which may include one or more of the Internet, cellular network, Wi-Fi, Wi-Max, a proprietary banking network, and so on. The mobile device 110, the account management computer system 130, and the merchant computer system 150 may each comprise a computer system (e.g., one or more servers each with one or more processors) configured to execute instructions, send and receive data stored in memory, and perform other operations to implement the operations described herein associated with logic or processes shown in FIGS. 2 through 21.

The mobile device 110 may be used by an individual user (e.g., an account holder) to create and interact with the user rewards account 137. The mobile device 110 may, for example, be a cellular phone, smart phone, mobile handheld wireless e-mail device, personal digital assistant, portable gaming device, or other suitable device. The mobile device 110 includes a network interface 112, a display device 114, and an input device 116. The network interface 112 may include, for example, program logic that connects the mobile device 110 to the network 160. The network interface 112 may include a mobile web browser for connecting the mobile device 110 to the network 160 and allowing the user to access a mobile rewards site 170 (shown in FIG. 1B) for managing the user rewards account 137. As described in greater detail below, for example, the mobile device 110 may receive and display screens including account information, transaction instructions, and so on. Such screens may be provided upon accessing the mobile rewards site 170. In one embodiment, such screens may be used to request username and password information. Such screens may also be used to prompt the user to provide information regarding a selected payment method (e.g., user rewards redemption option) and which merchant or individual (e.g., a selection of a recipient by the user from his memory or from the mobile device 110) is to receive the payment. Such screens are presented to the user via the display device 114. The input device 116 may be used to permit the user to initiate account access and to facilitate receiving requested information from the user. As will be appreciated, in addition to or instead of the mobile device 110, users may also be provided with the ability to access the user rewards system 100 using another type of computer (e.g., a desktop or laptop computer executing browser software) to perform the operations described herein as being performed by the mobile device 110. The mobile rewards site 170 may also refer to an application (e.g., a mobile application) provided on the mobile device 110 and configured to provide access to the user rewards account 137 via the network 160. For instance, the application may be provided by a financial institution that manages or provides the user rewards account 137 and/or a financial account of the user.

The network interface 112 may comprise program logic executable by the mobile device 110 (e.g., by processor 120) to implement at least some of the functions described herein. In one embodiment, the network interface 112 is stored on memory 122. The network interface 112 may simply be a web browser that is configured to receive and display mobile web pages received from the account management computer system 130 (e.g., web pages prompting the user to provide information to create an account, web pages displaying rewards account information and past transactions, and so on), which may include the mobile rewards site 170. The network interface 112 may also include a code generator capable of generating a unique code (e.g., token, barcode, image, pattern, etc.) for use in executing a transaction with a merchant. For instance, the unique code may be transmitted by the mobile device 110 as part of a transaction to facilitate authentication of the transaction.

The mobile device 110 also includes location determination logic 118. The location determination logic 118 determines the location of the mobile device 110 for use by the account management computer system 130, such as to provide user rewards redemption options near the user. A user may opt-in to using the location determination logic 118 to receive location-based reward point bonuses or point redemption offers, as described below. The location determination logic 118 may use a satellite (GPS) sensor included within the mobile device 110 or cellular towers to determine the location coordinates of the mobile device 110.

The account management computer system 130 includes account processing logic 134, an accounts database 136, network interface logic 132, and a profile database 138. In an example embodiment, the computer system 130 is operated by a financial institution that stores and manages transaction processing for the user rewards accounts. For example, the user rewards accounts may be created via interaction of the mobile device 110 (e.g., the network interface 112) with the account management computer system 130. The user may or may not have conventional bank accounts with the banking entity or financial institution that maintains the computer system 130. If the user does not have bank accounts with the entity that maintains the computer system 130, then accounts associated with another banking entity may also be used and stored with or accessible by the account management computer system 130. The flow of funds into and out of the user accounts may also be processed by the banking entity using the account management computer system 130.

The computer system 130 is configured to store information regarding user rewards accounts. By way of example, information for a specific user rewards account 137 is shown as being stored in the accounts database 136. As will be appreciated, database 136 may also store information regarding many other user rewards accounts (not shown). Transaction details, including user rewards information, may be tracked and maintained in the account processing logic 134. The account processing logic 134 may also include account selection logic that allows a user to choose any one of a plurality of rewards accounts or rewards IDs to redeem user rewards points (e.g., in exchange for a gift card or stored value card from a merchant) for purchasing goods or services, or to browse stored user rewards. An account holder may select a default rewards account or rewards ID that the account holder uses to store rewards points or other rewards, or to make payments. The account holder may use the account selection logic to select a desired account in order to redeem rewards points.

The account processing logic 134 may also include a rewards account aggregator that may be configured to add or subtract balances (e.g., point balances) of rewards accounts that are held or owned by the account holder. The rewards account aggregator may also provide the account holder with the ability to manage (e.g., add, edit, delete, etc.) rewards accounts that are stored within the account management computer system 130. The account processing logic 134 may further include value card management logic that may provide the account holder with the ability to manage (e.g., add, edit, delete, and so on) value cards stored within the user rewards accounts. In one embodiment, the value card may be a merchant-issued card with a balance that represents a specific amount of funds. The stored value card may be a virtual card that has an identification number and a value. The value card management logic may also store discounts or other offers received from merchants and associated with a stored value card. The funds associated with the virtual card can be accessed without a physical card. In one embodiment, the value card management logic is configured to store value information with respect to a plurality of different value card issuers (e.g., merchants). For example, the value card information regarding various value card issuers may be saved in a single user rewards account (e.g., account 137).

The user rewards account 137 holds rewards balances and other user rewards associated with the account 137, such as merchant value cards. The user rewards (e.g., a merchant value card) may be redeemed in exchange for value in a transaction with a merchant. For instance, a stored value card may be redeemed in order to purchase goods or services in a point of sale transaction with a merchant. The value card may be transmitted from the user rewards account 137 to the merchant upon receiving instructions from the account holder through the mobile device 110 (e.g., when a transaction is authorized). The user rewards account 137 or the account management computer system 130 may also store funds that may be transmitted to the merchant upon receiving instructions from the account holder through the mobile device 110. The network interface logic 132 may include, for example, program logic that connects the computer system 130 to the network 160.

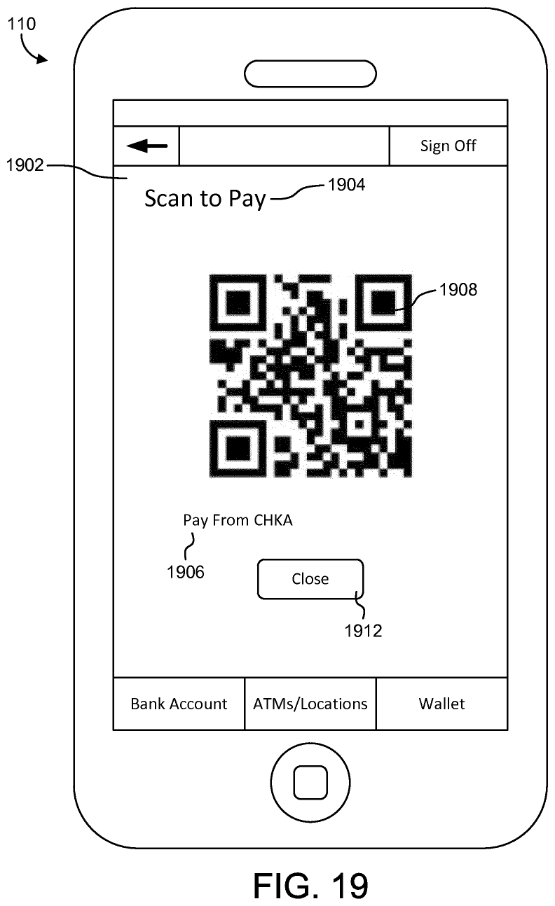

The account management computer system 130 includes code generator 140, accounts database 136, and profile database 138. The account management computer system 130 is configured to receive a request from an account holder to initiate a transaction, such as to redeem rewards points or a stored value card associated with the account 137 at a merchant point of sale location. The code generator 140 may be configured to generate a code (e.g., QR code, barcode, etc.) that can be scanned by the merchant or the account holder to initiate the transaction, such as code 1908 (shown in FIG. 19). Generating the code may include embedding in the code information related to the transaction, including a transaction identification number, a geographic location of the merchant, a timestamp, or other identifying information. The code may also include any merchant offers or discounts to be applied with the transaction, such as those accepted or otherwise received by the account holder in conjunction with the transaction. In some embodiments, the code generator 140 can be configured to generate optically scannable or non-optically scannable codes. Examples of optically scannable codes include bar codes, two dimensional codes (e.g. QR code and other similar codes), three dimensional codes (e.g. QR code with color and other characteristics), and four dimensional codes (e.g. QR code with color and timestamp information). Examples of non-optically scanned codes may include near field communication (NFC), RFID, HID or other RF signals to transmit the code.

As an example, the code may be generated in response to the account holder selecting a stored value card as a payment method for the transaction via the mobile device 110 (e.g., the network interface, the input device, etc.). In one embodiment, the code is generated to be displayed on the mobile device 110. In this embodiment, the account holder may display the code for a merchant to scan at a merchant point of sale device (e.g. cash register). The merchant may scan the code from the mobile device 110. The merchant point of sale device (e.g., merchant computer system 150) may be configured to amend the code to add further authentication information to the code or to include any applicable offers or discounts to the code and send the code to the financial institution (e.g., the account management computer system 130). The financial institution may receive the amended code from the merchant to complete the transaction, which may include transferring funds from an account held by the account holder (e.g., stored on the account management computer system 130) to an account held by the merchant (e.g., at the merchant computer system 150) and/or adjusting the balance of the user rewards account 137 (e.g., a stored value card, a rewards point balance, a cash account, etc.) accordingly.

In another embodiment, the code generator 140 may receive a request for a code to provide to a merchant. The code is generated to be displayed on a merchant point of sale device (e.g., merchant computer system 150). The merchant may display the code for the account holder to scan using a mobile device (e.g., mobile device 110). The banking entity or financial institution that maintains the computer system 130 may send the code to the merchant 150 for the mobile device 110 to scan. The code may include an offer or discount from the merchant 150 related to the transaction, such as an offer or discount provided in response to point redemption for a merchant value card. The mobile device 110 may scan the code from a merchant display device (e.g., a monitor of a cash register). The mobile device 110 may amend the code to add further authentication information to the code or to include an offer or discount provided by the merchant 150 and send the code to the financial institution. The financial institution may receive the amended code from the mobile device 110 to complete the transaction, which may include any of the actions described above.

The account management computer system 130 may also include offer engine 142. The offer engine 142 may be configured to receive information regarding past transactions conducted by the account holder or associated with the user rewards account 137 in order to provide offers related to the user's transaction history. For example, the account holder may opt in to receive offers that are selected as being likely to be considered relevant or helpful by the account holder. As described in greater detail below, the transaction information may be analyzed to obtain information regarding stores frequently visited by the account holder, the amount of money the account holder typically spends at various types of stores, the monthly spending habits of the account holder, the timing of income payments received by the account holder, seasonal spending patterns of the account holder, and so on. In another embodiment, the offer engine 142 may download new or updated offers from the merchant computer system 150 based on the account holder's geographic location.

In another embodiment, the offer engine 142 is configured to present offers, in the form of an alert, to an account holder based on a selection to redeem rewards points or other user rewards. For example, when an account holder elects to redeem rewards points or another reward to complete a transaction at a merchant point of sale location, the offer engine 142 may generate a message that is displayable on the display 114 as an alert. The message may include an offer or discount (e.g., from the merchant 150) available to the account holder for use within the transaction (i.e., such that the offer or discount applies to the present transaction) and details regarding the offer (e.g., amount of discount, offer restrictions, etc.). The details regarding the offer may include an amount or percentage discount available, an item or service that is being offered at a discounted price, additional rewards points available to the account holder for a particular purchase, offer restrictions, and/or other information relevant to the offer. The alert may be included as part of an icon used to select a particular redemption option or delivered separately upon selection of the redemption option. As part of displaying the alert, an overlay display may also be generated, which may be accompanied by a vibration and/or sound.

The accounts database 136 may store details regarding user rewards accounts or other accounts related to a user of the system 100. In particular, the accounts database 136 may store information related to each financial transaction that is processed using the user rewards system 100 within the accounts database 136 or otherwise within the account management computer system 130. Each stored financial transaction may include a value of goods and/or services received within the transaction, a merchant associated with the transaction, a payment method used (e.g., rewards points redemption, merchant value card, etc.), an account holder associated with the transaction, and other information relevant to a function or process of the system 100. In one embodiment, the user may determine transaction information that is stored by modifying user preferences via the mobile rewards site 170.

The account management computer system 130 may also include profile database 138. The profile database 138 may store other information regarding the account holder. For example, the profile database 138 may store information useful for generating offers and advertisements that are selected specifically for the account holder.

The merchant computer system 150 may be used at a point of sale to conduct a transaction with the account holder. For example, the merchant computer system 150 may comprise a point of sale computer system such as a cash register system connected to a central server system operated by the merchant. As another example, the merchant computer system 150 may comprise a mobile computing device (e.g., smart phone, tablet PC, etc.) operated by a store clerk as the clerk moves throughout the store. Again, the mobile computing device in such an embodiment may connect to a central server system operated by the merchant.

The merchant computer system 150 includes network interface logic 152, code scanner 154, offer management logic 158, and payment logic 156. In one embodiment, the network interface logic 152 is configured to allow the merchant computer system 150 to communicate with the mobile device 110 and the account management computer system 130 via the network 160. The network interface logic 152 sends and receives data from the mobile device 110 and the account management computer system 130.

The code scanner 154 may be configured to scan codes, such as but not limited to, optically scannable or non-optically scannable codes. Examples of optically scannable codes include bar codes, two dimensional codes (e.g. QR code and other similar codes), three dimensional codes (e.g. QR code with color and others characteristics), and four dimensional codes (e.g. QR code with color and timestamp information). Examples of non-optically scannable codes include near field communication (NFC), RFID, HID or other RF signal to transmit the code. Code scanner 154 may include a light emitting device that scans a code using infrared, laser, or other types of communication technology. After scanning the code, the code scanner 154 may be configured to determine the information that was incorporated into the code by the mobile device 110 that generated the code.

The offer management logic 158 may provide offers to the account holder from the merchant. The offers may be applied to the current transaction or stored within the user rewards account 137 for later use. The offers may be based on the current transaction, such as being in response to certain details of the current transaction. For instance, the offer management logic 158 may be configured to provide an offer when user rewards points or a stored value card (e.g., merchant value card) are redeemed by the account holder within a transaction. The offer may include a discount on the current transaction, an offer for additional discounted goods or services, an offer for bonus rewards points, and the like. The offer management logic 158 may also provide offers based on other rewards redemption offers provided within the user rewards account 137, based on one or more preferences of the account holder (e.g., determined via the accounts database 136), based on information provided to the merchant computer system 150 by the account holder, or based on other information available to the merchant computer system 150 as part of the system 100.

The offer management logic 158 may also be configured to apply selected discounts (e.g., applied by the user, provided by the merchant) to the current transaction. For instance, the user may select a discount that is offered by the merchant in connection with the current transaction. The offer management logic 158 may be configured to apply the offer to the current transaction and may provide a payment amount or another result (e.g., an updated rewards point total) based on the applied offer.

The payment logic 156 may be configured to communicate a funds request to the account management computer system 130 via the network interface logic 152. The payment logic 156 may be configured to receive an amount related to the transaction from the account management computer system 130. For instance, the payment logic 156 may receive the amount in the form of user rewards points or other user rewards. The amount of the transaction may also include any offers provided by the merchant via the offer management logic 158, such as those offer(s) applied to the current transaction. The payment logic 156 may be configured to apply the offer(s) to the transaction.

The merchant computer system 150 may further connect to or integrate with other hardware. For example, in one embodiment, the merchant computer system 150 may connect to a card reader for reading credit cards, debit cards, stored value cards, and so on. As another example, the merchant computer system 150 may be configured to prompt the user to provide a random security code. The random security code may be generated by the mobile device 110 or in another manner. The security code may be provided to the merchant computer system 150 directly by the mobile device 110, keyed into the merchant computer system 150 (e.g., by a store clerk), or received in another manner suitable for the system 100.

The merchant computer system 150 may be configured in generally the same manner as the other computer systems described herein (e.g., computer system 130, mobile device 110). The computer system 150 may comprise a computer system (e.g., one or more servers each with one or more processors) configured to execute instructions, send and receive data stored in memory, and perform other operations to implement the operations described herein associated with the merchant. In an exemplary embodiment, the mobile rewards site 170 is accessed by the mobile device 110 and used in connection with merchant computer system 150 located at an “in-store” or point of sale location. However, the mobile rewards site 170 may also be accessed by the mobile device 110 for use in connection with online merchant transactions.

In one embodiment, the user rewards system 100 may include another computer system similar to computer system 130 and operated by a second financial institution that maintains and handles transaction processing for source accounts of the user. In an example embodiment, during creation of the user rewards account 137 (e.g., via the mobile rewards site 170), the user may be prompted to identify a source account to provide a source of funds for transactions including a cash amount. The source account may also be used to purchase rewards points or other user rewards (e.g., merchant value cards) for storage within the user rewards account 137. The source account may be an existing demand deposit account held by the user with another financial institution. Thus, the financial institution that provides the user rewards account 137 for the user (through the online community) and the financial institution that typically provides banking services to the user may be two different financial institutions.

Referring now to FIG. 1B, a site map for mobile rewards site 170 is shown, according to an exemplary embodiment. The mobile rewards site 170 may be utilized by a user of system 100 to manage user rewards, initiate transactions using the user rewards, and perform other functions of system 100. In one embodiment, the user may navigate the mobile rewards site 170 using the mobile device 110 and according to the site map of FIG. 1B. Blocks of the site map correspond to screen displays of the mobile rewards site 170, which are shown in FIGS. 2-19 and described in detail below.

Referring now to FIGS. 2-19, screen displays of the mobile rewards site 170 are shown, according to an exemplary embodiment. For example, the screen displays may be shown as part of a mobile application accessible via the mobile device 110. In particular, screen 200 as shown in FIG. 2 may be displayed when a user (e.g., account holder) accesses the mobile rewards site 170 on their mobile device 110. Screen 200 shows an unauthenticated view of the site 170 in which the user may browse certain contents or features of the site 170 that do not require account authentication. Promotional space 214 may include any promotional material, including a logo for the mobile rewards site 170 or an advertisement from a merchant or other paid advertiser. From screen 200, the user may browse available user rewards (e.g., rewards points, merchant value cards, gift cards, etc.). In one embodiment, the user may also browse offers available with redemption of the user rewards (e.g., discounts, bonus points, deals, etc.) that may be tied to a specific merchant. The user rewards may include rewards points or may otherwise be purchased or obtained by redeeming rewards points accumulated by the user through an account loyalty program. The rewards points may be accumulated through purchases using the user rewards account 137 or a separate source account, which may be held by the financial institution supporting the user rewards account 137 or a separate financial institution. As an example, the source account may include a credit card account.

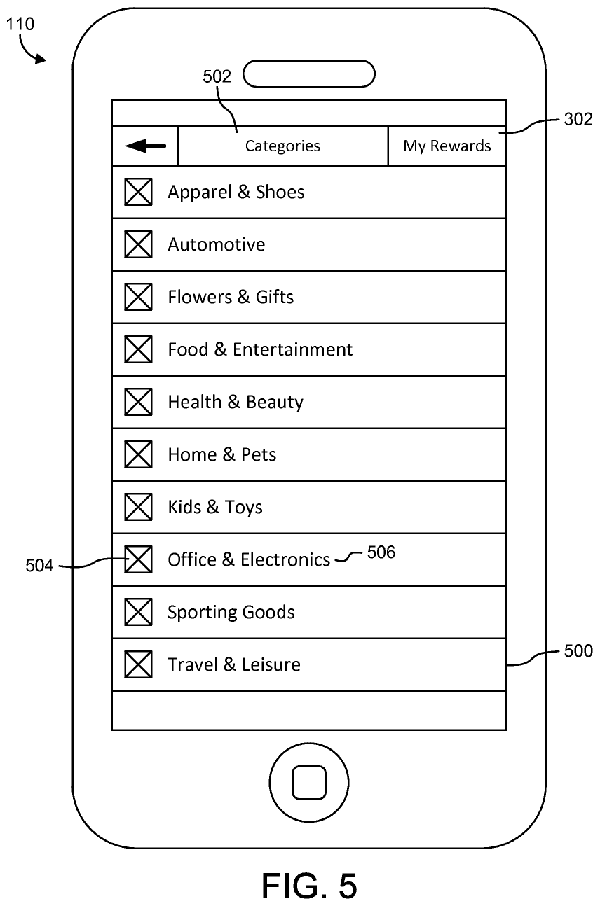

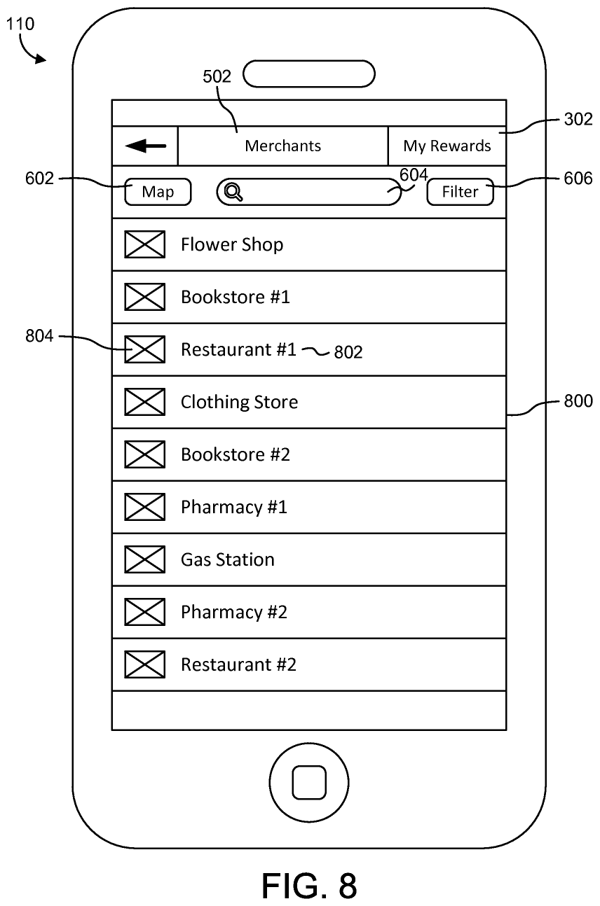

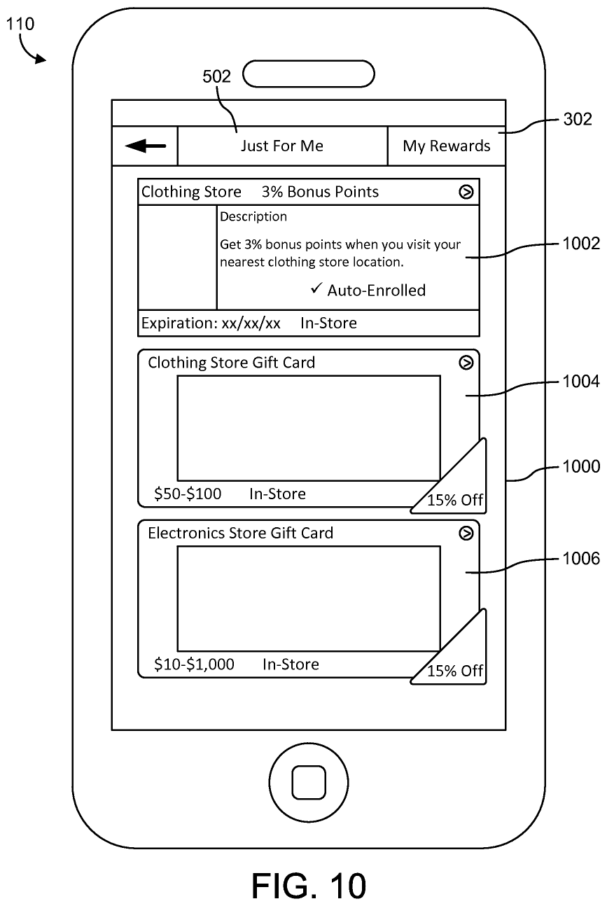

The user rewards and redemption options may be grouped or sorted according to a characteristic of the merchant issuing or associated with the user rewards, such as a merchant name or the type of goods or services provided by the merchant. For instance, the user may browse user rewards according to a category of goods or services provided by the merchant (e.g., automotive, apparel, sporting goods, etc.) by pressing ‘categories’ button 204 (see FIG. 5). The user may browse rewards according to the merchant name (e.g., Bookstore #1, Bookstore #2, Restaurant #1, etc.) by pressing ‘merchants’ button 206 (see FIG. 8). The user may also browse rewards according to a location of the merchant (e.g., nearest to mobile device 110, nearest to a designated location, etc.) by pressing ‘nearby’ button 208 (see FIG. 10). The user may also browse available travel rewards or digital downloads by pressing button 210 or button 212, respectively. The user rewards may be made available for purchase (e.g., using rewards points) once the account holder has been authenticated.

The account holder may be asked to provide a login ID (e.g., unique account name/number) and password in order to sign in to the mobile rewards site 170 (e.g., authenticate a user rewards account) upon pressing button 202. The account name/number and password may have been configured upon registration or set up with the mobile rewards site 170 and/or a related online banking site, and/or updated at a later date. For example, the account name/number and password may be the same as the user's online banking credentials. As another example, assuming that the user is signing on from the mobile device 110, the user may only be asked to provide a pin number (e.g., a 4-digit PIN), given that physical possession of the mobile device 110 may itself provide an additional layer of security. The PIN may be linked to or may be separate from the PIN that is used for a debit card held by the user. In other embodiments, other authentication techniques may be used (e.g., biometric authentication, image capture, facial recognition, speech recognition, fingerprint authentication, etc.).

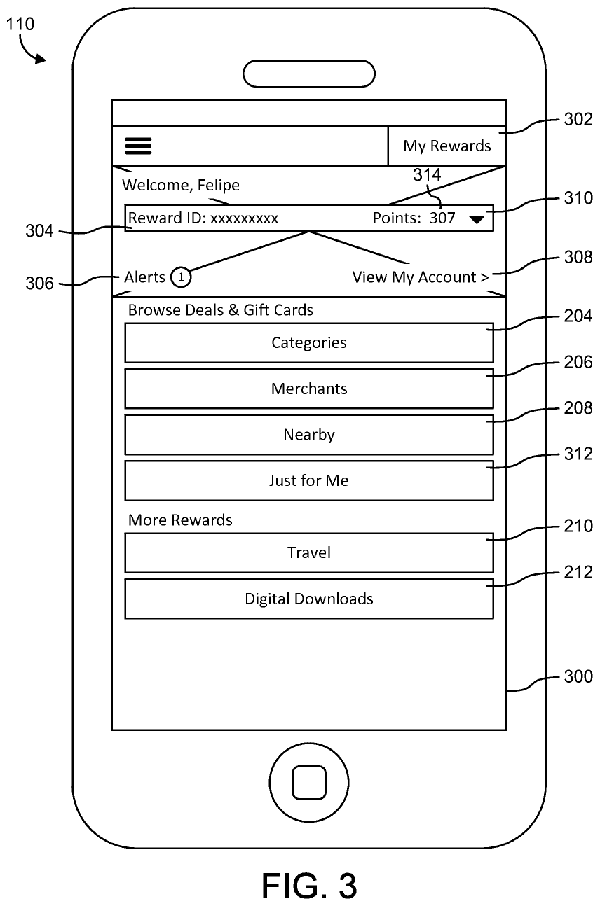

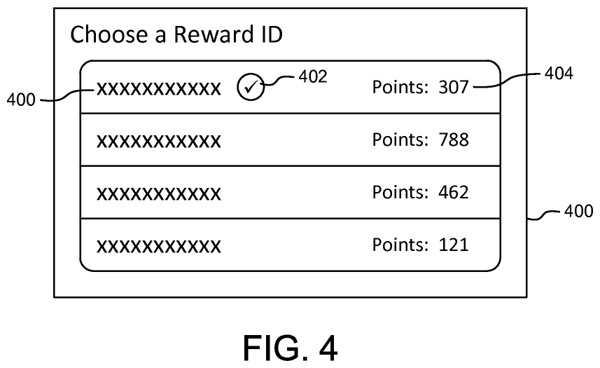

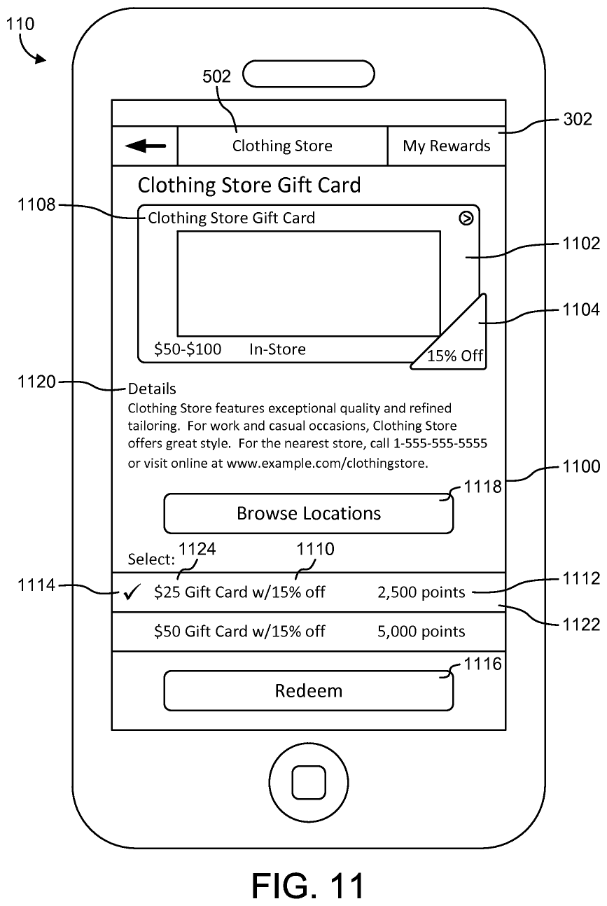

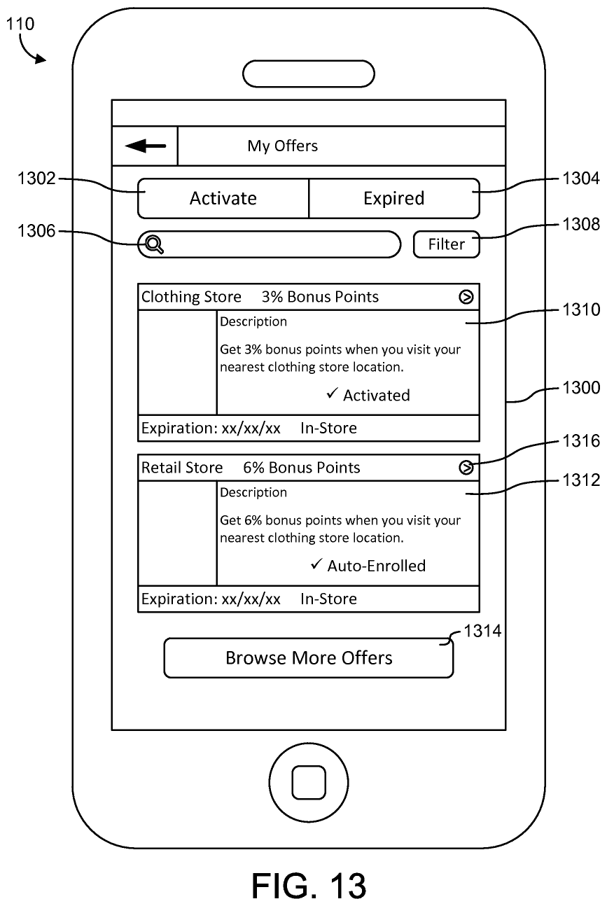

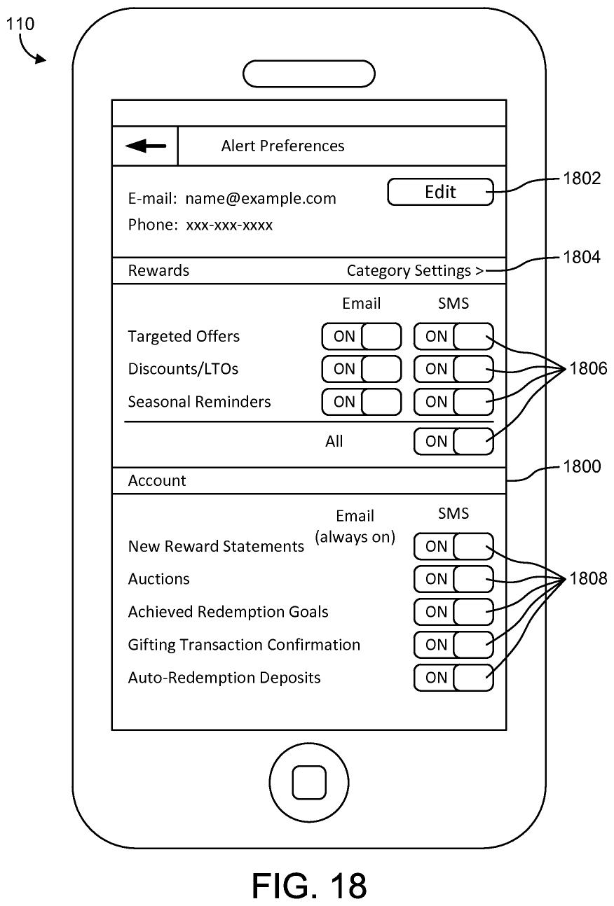

Once the user has been authenticated, screen 300 of FIG. 3 is available and displayed on the mobile device 110. The user is provided with account details, such as a rewards ID 304, a rewards point total 314 associated with the account of the rewards ID 304, and an alerts indicator 306. The alerts indicator 306 may indicate any alerts (e.g., recent transaction data, offers, rewards points received, etc.) that are unread or have been received within a designated time period (e.g., since last login, within the last week, since the alerts have been cleared, etc.). The user may review any alerts and/or other relevant account information by pressing button 308 to view further account details, as well as manage rewards points and rewards accounts (see FIG. 18). The user may select a different rewards ID for viewing by selecting dropdown menu 310 (see FIG. 4). The user may also view any user rewards that have been obtained or redeemed by pressing button 302 to view “My Rewards” (see FIG. 13). By signing in, the account holder (e.g., user) may also view available user rewards that are tailored to the account holder by pressing button 312 to reach the “Just for Me” menu (see FIG. 11).

If the user selects (e.g., presses) dropdown menu 310, screen 400 of FIG. 4 is displayed on the mobile device 110. Screen 400 shows the available rewards IDs, or rewards accounts, that are accessible to the user within the mobile rewards site 170. The user may have multiple rewards IDs related to separate rewards accounts, such as having a separate rewards account for each active credit card. The rewards accounts may be accessed and managed through the mobile rewards site 170. The user may select a rewards account by pressing screen 400 in the area of a desired account. Icon 402 may indicate which of the rewards accounts is selected or currently active (e.g., manageable, accessible, etc.). The rewards IDs are designated by a rewards account number 406 and a point total 404 is shown for each rewards ID. Screen 400 may be accessed by selecting (e.g., pressing) dropdown menu 310.

If the user selects the categories button 204 of screen 200, screen 500 of FIG. 5 is displayed on the mobile device 110. Heading 502 may provide an indication of how the user rewards redemption options (e.g., point redemption options) are sorted on the current screen. Screen 500 provides a listing of categories of merchant types for which user rewards may be available to the account holder. For instance, the categories may be based on the types of goods or services (e.g., apparel & shoes, automotive, flowers & gifts, etc.) provided by the merchant, as is displayed on the screen 500. The category of goods or services available is provided within a text box 506. The user may select a category (e.g., view user rewards redemption options related to the category of goods or services) by pressing a button next to a desired category name. For instance, the user may view merchant offer options related to office and electronics goods and/or services by pressing button 504 on the screen 500.

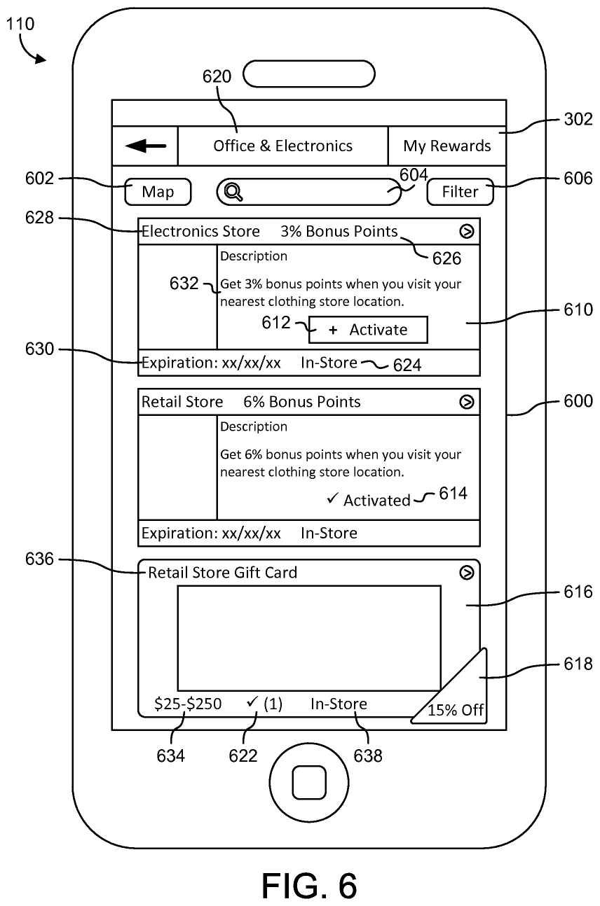

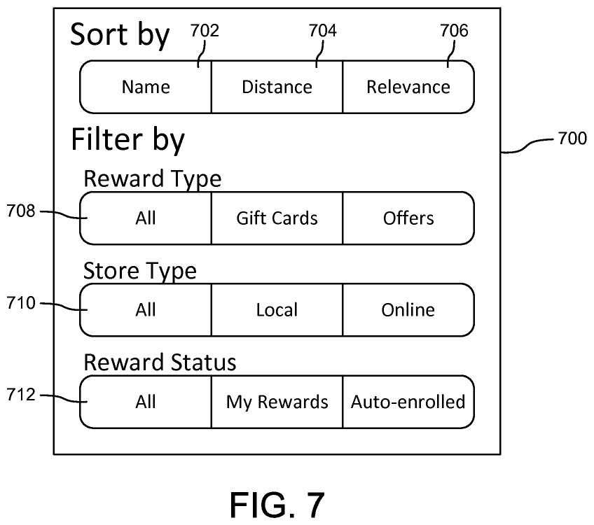

If the user presses button 504 to select the category “Office & Electronics,” screen 600 of FIG. 6 is displayed on the mobile device 110. The screen 600 includes user rewards available for redemption or activation that provide the goods or services of the selected category (e.g., Office & Electronics). The user may search within the selected category by selecting search field 604. When search field 604 is selected, the user may be prompted to provide search terms, such as a keyword or a location, to narrow the list of user rewards redemption options to a specific set of desired rewards options. Similarly, the user may select button 606 to filter the user rewards redemption options based on specific aspects of the user rewards (see FIG. 7). The user may also select button 602 to display a map. The map may provide a location for each of the displayed user rewards redemption options. The map may include the user's current location (e.g., determined by a GPS of the mobile device 110) and a location of the nearest merchants at which one or more user rewards may be redeemed (e.g., a location at which a merchant value card may be redeemed for goods and/or services).

Each user rewards redemption option displayed on screen 600 includes information related to the user rewards redemption option. As an example, reward emblem 610 represents a user reward including bonus rewards points in connection with a transaction at Electronics Store. Reward emblem 610 displays a bonus amount 626, a merchant name 628, an expiration date 630, a brief description 632, and a location restriction 624 (e.g., in-store, online, within the U.S., etc.) related to the rewards redemption option associated with the emblem 610. The bonus amount 626 refers to the number of bonus rewards points available to the user for a transaction with the merchant 628 (if the reward is redeemed). The bonus amount 626 is displayed as a percentage of a payment amount for the associated transaction, but the amount 626 may also be displayed as a total amount of points available for one or more transactions. The expiration date 630 may provide a date by which the rewards redemption option expires (e.g., date by which the reward must be activated or redeemed), or a date when an activated reward will expire (e.g., date until bonus rewards points may be received). If the user presses button 608, a detailed view of the rewards redemption option may be provided, which may include additional information related to the associated reward.

The user may activate (e.g., redeem) the user reward by pressing button 612. Once the button 612 is pressed, the reward may be automatically activated to receive bonus rewards points in a transaction with the merchant 628. For instance, the reward may be provided as an option as a result of a prior transaction, subject to activation by the user, and the reward may be activated (e.g., for a designated period of time) at any time by the user by pressing the button 612. In other embodiments, the user is required to perform further actions to activate the reward once the button 612 is pressed. For instance, the user may be required to redeem an amount of rewards points or purchase one or more items (e.g., amounting to a minimum payment amount, specific item(s), etc.) to activate the reward. As another example, the user may be required to de-activate another user reward in order to activate the reward represented by the reward emblem 610. When the reward is activated, an indication such as icon 614 may be displayed within the reward emblem 610.

Reward emblem 616 represents a user rewards redemption option of a gift card (e.g., merchant value card, merchant-issued value card, stored value card, etc.) for use in a transaction with a merchant. Reward emblem 616 displays a value card amount 634, a merchant name 636, an indication 622 of any stored value cards for the merchant 636, a location restriction 638, and a badge 618 from the merchant 636, each related to the associated gift card. In an exemplary embodiment, the gift card is a value card that may be exchanged for goods or services available from the merchant 636. The value card may be issued by the merchant 636. The merchant 636 may issue the value card based on, such as in exchange for, rewards points accumulated by the user and redeemed using the mobile rewards site 170. For instance, the user may redeem rewards points for a merchant value card redeemable at a point of sale location for goods or services (e.g., using the mobile rewards site 170). The value card amount 634 may indicate a range of values available for purchase or redemption and applicable to the merchant value card. Merchant value cards having higher values may be purchased or obtained by redeeming more rewards points. The indication 622 may let the user know if and how many merchant value cards have been purchased for use with the merchant 636. In another embodiment, the merchant 636 may issue the value card in exchange for a cash payment from the user account 137 (e.g., using the mobile rewards site 170).

In one embodiment, the merchant value card is provided by a financial institution. For instance, the financial institution may provide the merchant value card to the user in exchange for rewards points or as a user reward in exchange for one or more purchases or other transactions with the merchant. A requisite amount of funds may be transmitted to the merchant when the value card is redeemed, or the value card may be redeemed in exchange for rewards points or other user rewards. In one embodiment, a financial institution may issue a merchant value card to the user (e.g., as a user reward, in exchange for rewards points, etc.) and transmit a requisite amount of funds to the merchant when the value card is redeemed. In another embodiment, the merchant value card is provided by the merchant without a cash payment. For instance, the merchant may provide the merchant value card to the user in exchange for rewards points (e.g., rewards points earned via transactions with the merchant) or as a merchant offer in conjunction with a transaction.

The user rewards redemption options may also include a stored value card not associated with a specific merchant. For instance, the stored value card may be an open loop prepaid card having a cash value or balance that is useable in a transaction with a variety of merchants. For instance, a financial institution may provide the stored value card in exchange for redemption of rewards points or separately as a user reward. In one embodiment, the stored value card is provided to the user in exchange for redemption of rewards points. In this embodiment, the stored value card may be provided with a balance (e.g., cash value, transaction value, exchange value, etc.) that is commensurate with the amount of rewards points redeemed. The stored value card may be stored within the user account 137 and accessible for use in a transaction with one or more merchants via the mobile rewards site 170.

The badge 618 indicates an offer available from the merchant 636 (i.e., a merchant offer). The offer may be applied or redeemed when the merchant value card is used as a form of payment in a transaction with the merchant 636. In the illustrated embodiment, the offer is for a percentage discount or reduced price for goods or services purchased from the merchant 636. The offer may also be another offer applicable to a transaction for goods or services from the merchant 636, including a total cash discount on a purchase, bonus rewards points available in conjunction with a purchase using the value card, an offer based on a particular item of goods or services (e.g., buy one item, get a similar item 50% off, etc.), or the like. The offer may be provided by the merchant 636 in conjunction with the value card offer. For instance, in one embodiment the user may redeem rewards points for a merchant value card having a designated value, and the offer may be automatically attached or connected to the value card when the rewards points are redeemed. In this embodiment, the offer may be maintained with the value card until the value card is redeemed for goods or services from the merchant 636. In another embodiment, the offer may be offered and/or accepted at the time of the transaction (e.g., when the merchant value card is redeemed). The offer may be variable, such as being based on the user's activity (e.g., prior transactions, current location, internet activity, calendar items, etc.). The offer may be applied to the transaction when the value card is redeemed. For instance, the user may receive a percentage discount on any goods or services purchased from the merchant 636 using the value card. The offer may be applicable to only in-store purchases, only online purchases, or subject to another restriction, which may be displayed in a detail view of the reward emblem 616.

If the user presses button 606 to filter the user rewards, screen 700 of FIG. 7 is displayed on the mobile device 110. The screen 700 includes options for sorting or filtering the user rewards redemption options according to user preferences. The user may press button 702 to sort the user rewards redemption options by name, button 704 to sort the user rewards redemption options by location (e.g., nearest to the current location of mobile device 110), or button 706 to sort the user rewards redemption options by relevance (e.g., according to stored user preferences). The user may also press buttons 708 to filter the user rewards redemption options by the type of reward available (e.g., gift cards, bonus rewards points, discounts, etc.), buttons 710 to filter the rewards options by store type (e.g., local store, online store, etc.), or buttons 712 to filter the user rewards redemption options by status (e.g., my rewards, selected, auto-enrolled, etc.).

If the user selects the merchants button 206 of screen 200, screen 800 of FIG. 8 is displayed on the mobile device 110. Screen 800 provides a listing of merchant names 802 for which user rewards may be available to the account holder. For instance, the merchant names 802 may be provided in alphabetical order, according to user preferences, or according to most recent transactions of the user. The user may select a particular merchant (e.g., to view user rewards redemption options available for the merchant) by pressing a button next to a desired merchant name. For instance, the user may view user rewards related to “Restaurant #1” by pressing button 804. If the user selects or presses the button 804, a screen similar to screen 600 is displayed on the mobile device 110 for the user to view available user rewards for Restaurant #1.

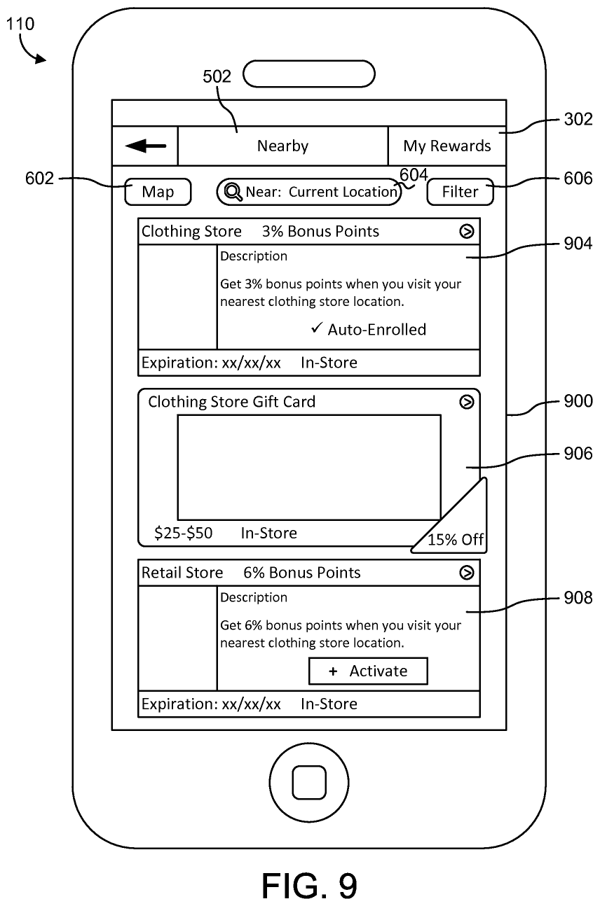

If the user selects the nearby button 208 of screen 200, screen 900 of FIG. 9 is displayed on the mobile device 110. Screen 900 provides a listing of the user rewards redemption options nearest to a location of the user (e.g., a current location of the mobile device 110). For instance, the user rewards redemption options of merchants nearest to the user may be displayed (e.g., according to GPS coordinates of the associated mobile device 110). The screen 900 includes search field 902. The user may select the search field 902 and enter an alternate location for searching nearby user rewards. As an example, the user may enter a work address and search user rewards nearest the work address. The emblems 904, 906, and 908 represent user rewards redemption options near a selected location and are similar to those shown in FIG. 6.

If the user selects the button 312 (e.g., Just for Me button) of screen 300, screen 1000 of FIG. 10 is displayed on the mobile device 110. Screen 1000 provides a listing of the user rewards redemption options tailored to one or more preferences of the user. For instance, screen 1000 may display user rewards related to a favorite merchant of the user (e.g., as selected within a user preferences area of the mobile rewards site 170). The screen 1000 may also display user rewards redemption options related to recent transactions of the user. For instance, if the user recently used the mobile rewards site 170 and/or the user account 137 to purchase a plane ticket, the screen 1000 may display user rewards redemption options related to travel, such as for merchants that specialize in luggage or other travel accessories. Emblems 1002, 1004, and 1006 represent user rewards redemption options that are displayed based on one or more preferences and/or behaviors of the user. The emblems 1002, 1004, and 1006 are similar to those shown in FIGS. 6 and 9 and include similar features, as described above in references to those FIGS.

If the user selects the emblem 1004 to view the user reward redemption option for “Clothing Store,” screen 1100 of FIG. 11 is displayed on the mobile device 110. Screen 1100 provides details related to the selected user reward redemption option. Screen 1100 also provides an option for redeeming rewards points in exchange for another selected user reward. The screen 1100 includes an emblem 1102 representing the user reward. The emblem 1102 includes merchant name 1108 (e.g., Clothing Store), badge 1104 indicating a merchant offer available for redemption in a transaction involving the user reward, and indicator 1106 providing an indication of a location type where the user reward may be redeemed. The screen 1100 includes details 1120 related to the merchant, which may include merchant contact information. The user may browse merchant locations by pressing button 1118. The user may be directed to a different screen, such as a map, for displaying merchant locations at or near a location of the user or another selected location. The screen 1100 also includes button 1122 that may be pressed by the user to select a point redemption option. A rewards point total 1112 associated with the point redemption option is shown. The rewards point total 1112 represents and amount of loyalty points that must be redeemed to obtain the selected user reward. The point redemption option also includes a value 1124 associated with the user reward (e.g., a payment amount associated with the user reward) and a merchant offer 1110 associated with the user reward. The merchant offer 1110 may be applied to a transaction in which the merchant value card (i.e., the user reward) is used as a payment method. Icon 1114 indicates that a point redemption option has been selected. When the desired point redemption option has been selected, the user may press button 1116 to redeem the amount of rewards or loyalty points shown in the rewards point total 1112 for a merchant value card having the value shown in value 1124. When the rewards points are redeemed, the merchant value card is stored within the user account 137 and accessible via the mobile rewards site 170 for use in purchasing goods or services from the merchant.

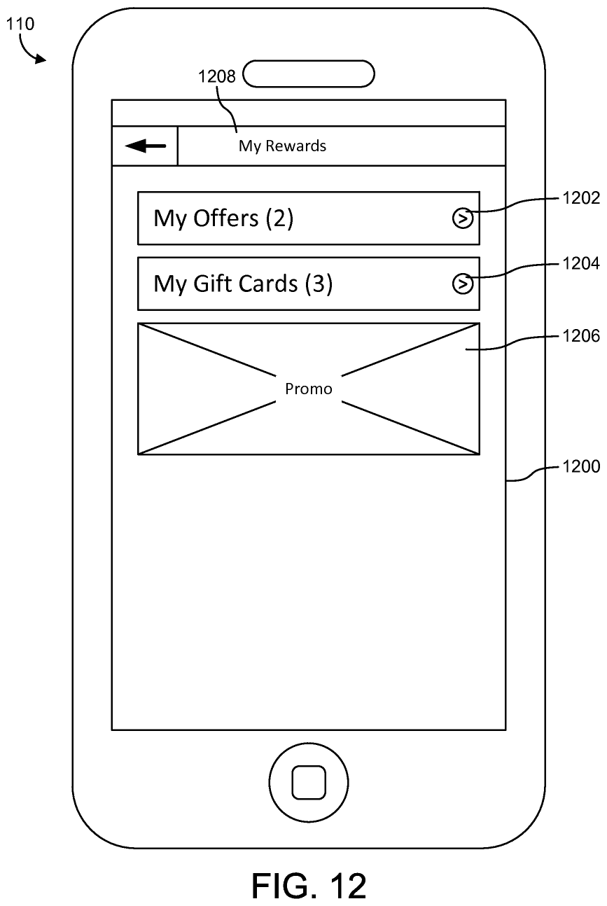

If the user presses the button 302 (e.g., My Rewards button), screen 1200 of FIG. 12 is displayed on the mobile device 110. Screen 1200 provides a display of the user rewards currently stored within the user account 137 and available for use via the mobile rewards site 170. The user can view offers accepted by the user (e.g., “My Offers”) by pressing button 1202. The number of offers accepted (e.g., stored within “My Rewards”) is indicated within parentheses. The user can view gift cards accepted or “purchased” by pressing button 1204. The number of gift cards accepted is indicated within parentheses. The screen 1200 includes promotional space 1206. Promotional space 1206 may be used for advertising, such as advertisements tailored to the user, such as based on user preferences. Promotional space 1206 may also be used to display a logo for the financial institution, a merchant, or another entity associated with the user or with the mobile rewards site 170. Promotional space 1206 may also be used to display one or more messages related to the user, such as messages from another user of the mobile rewards site 170 or a reminder or memo provided by the user. Banner 1208 indicates to the user that stored user rewards are being displayed.

If the user presses the button 1202, screen 1300 of FIG. 13 is displayed on the mobile device 110. Screen 1300 provides a display of offers accepted by the user, both active and expired. The user is able to toggle between active offers and expired offers by pressing button 1302 and button 1304, respectively. The user can search offers by keyword by selecting search field 1306 and entering text to search for stored offers. The user can also narrow or search for offers by pressing button 1308 to filter the stored offers. For instance, the stored offers may be sorted or filtered by expiration date, activation date, an activation method, an offer type, and the like. Emblem 1310 and emblem 1312 represent offers stored within the user account 137 and available for use via the mobile rewards site 170. Emblems 1310 and 1312 display information similar to the information displayed in the emblems shown in FIG. 6. The user may see details regarding an offer by selecting the offer. For instance, the user may see details or other information for the offer represented by emblem 1312 by pressing button 1316. The user may browse more offers by pressing button 1314. For instance, button 1314 may be used to scroll through offers when all stored offers are unable to fit at once on screen 1300.

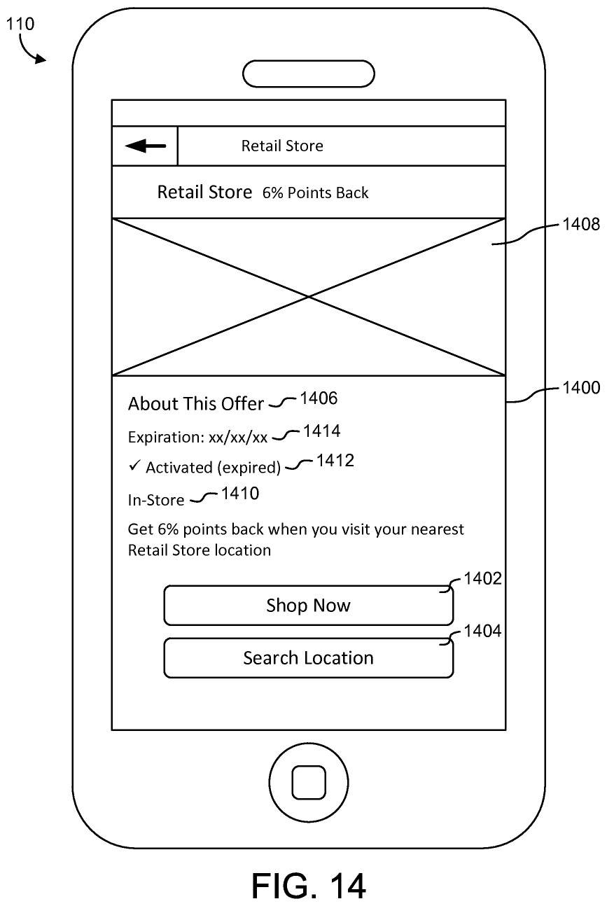

If the user presses the button 1316, screen 1400 of FIG. 14 is displayed on the mobile device 110. Screen 1400 shows details 1406 of a bonus points offer available in conjunction with a transaction with “Retail Store,” such as the terms of the offer (e.g., 6% points back when the user visits nearest Retail Store location). The details 1406 may include an expiration status 1412 of the offer, a location limitation 1410, an expiration date 1414, or other details or information that may be useful to the user or otherwise related to redemption of the offer. The expiration date 1414 may indicate a date when an activated offer expires or when a merchant offer may no longer be accepted by the merchant. Expiration status 1412 indicates whether the offer is valid or expired. The expiration status 1412 may be toggled between two different colors to indicate the status of the offer (e.g., green when valid, red when expired) or may provide another visual indication (other than the text) of the expiration status of the offer. The location limitation 1410 may indicate limitations on redemption of the offer, such as whether the offer may be redeemed at an in-store location, online, or within a certain area or location (e.g., nearest the user). Promotional space 1408 may be used for advertisements or other promotions. If the offer is redeemable via an online transaction, the user may access an online store of the merchant by pressing button 1402. Otherwise, the button 1402 may provide a nearest in-store location at which the offer may be redeemed. The user may find the nearest location for using the offer by pressing button 1404 to access a map of merchant locations. The locations may be filtered to include only those locations at which the offer may be redeemed or used, or according to a location specified by the user.

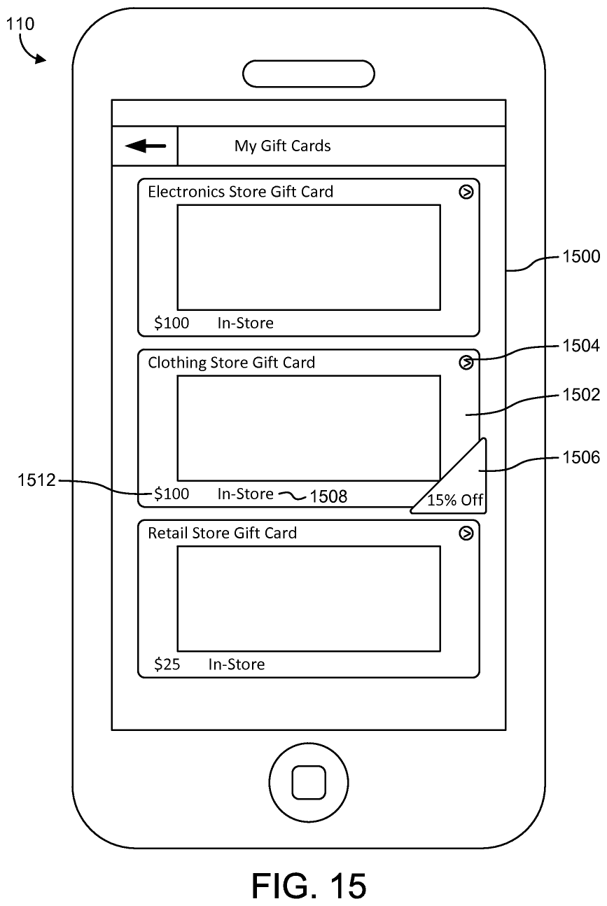

If the user presses the button 1204, screen 1500 of FIG. 15 is displayed on the mobile device 110. Screen 1500 provides a display of gift cards stored by the user. The gift cards (e.g., value cards) may have been purchased (e.g., redeemed) by redeeming rewards points, as described above, received as gifts and stored within the user account 137, or accepted as offers from a merchant. Each of the value cards are represented by emblems on the screen 1500. The user can view details of a value card by selecting the emblem on the screen 1500. Emblem 1502 indicates a merchant name 1510, a value amount 1512, and a location limitation 1508. Emblem 1502 also includes a badge 1506 that indicates a merchant offer is available or accepted for a transaction made with the merchant 1510 using the value card represented by emblem 1502. In this embodiment, the merchant offer is a discount on the total cost of goods or services purchased using the value card. The merchant offer may be applied to a transaction between the user and the merchant using the mobile rewards site 170. The merchant offer may be applied at the time the value card is redeemed at a point of sale location. The user may view further details of the merchant offer and the stored value card by pressing button 1504.

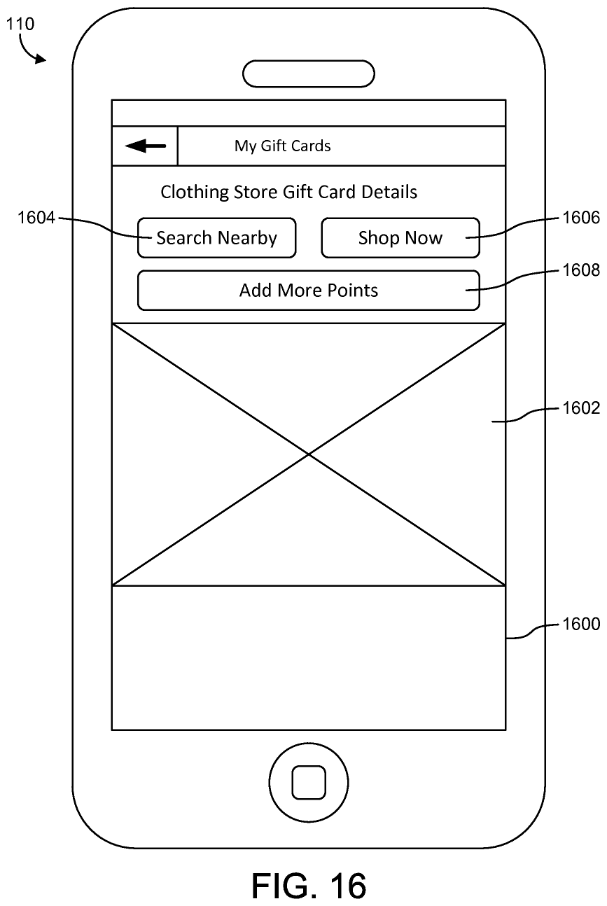

If the user presses the button 1504, screen 1600 of FIG. 16 is displayed on the mobile device 110. Screen 1600 shows details of a value card stored within the user account 137 and available for use as payment in a transaction with “Clothing Store” using the mobile rewards site 170. The details may be included within information space 1602. The details may include an expiration status of the value card, a location limitation, an expiration date, a merchant offer (e.g., discount) attached to or available in conjunction with the value card, or other details or information that may be useful to the user. If the value card is redeemable for payment via an online transaction, the user may access an online store of the merchant (e.g., Clothing Store) by pressing button 1606. Otherwise, the button 1606 may provide the nearest in-store location at which the value card may be redeemed. The user may find the nearest location for using the value card as payment for an in-store transaction by pressing button 1604 to access a map of merchant locations. The locations may be filtered to include only those locations at which the value card may be redeemed or used, or according to a location specified by the user. The user may also add more points or value to the value card by pressing button 1608. The user may be directed to a screen similar to screen 1100 of FIG. 11, whereby user may be able to add value to the selected value card by redeeming rewards points from one or more of the user's rewards accounts. The additional value may include value applied to the transaction separately (without any discount or other merchant offer). The user may also attach different merchant offers to the additional value if any other merchant offers are available at the time of redemption.

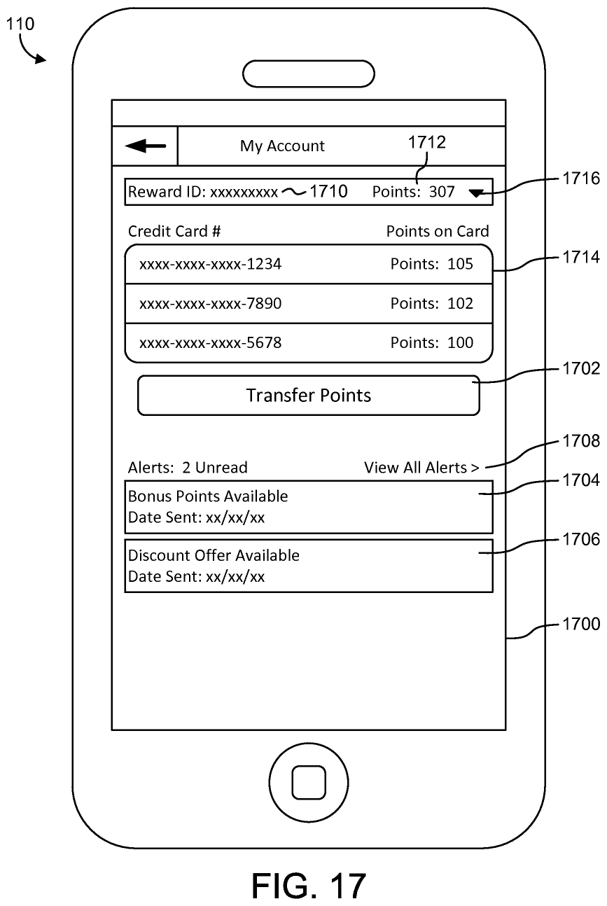

If the user presses the button 308 of screen 300, screen 1700 of FIG. 17 is displayed on the mobile device 110. Screen 1700 shows account details for a selected rewards ID 1710, including a rewards point total 1712 and table 1714 that provides a breakdown of the rewards points by credit card associated with the user's rewards ID 1710. The user may select a different rewards ID associated with the user account 137 by pressing button 1716 and selecting a desired rewards ID. The screen 1700 also includes alerts related to the rewards ID. The alerts shown may be those that are unread or those that have been received within a designated time period. The alerts may be related to available merchant offers. The alerts may also include messages from a financial institution, a merchant, or another user of the mobile rewards site 170. For instance, alert 1704 indicates bonus points are available for a transaction with a merchant. The alert 1704 includes a date 1718 that the alert 1704 was received or sent. Alert 1706 is related to a merchant offer (e.g., a discount) available for use in a transaction with a merchant using the mobile rewards site 170. The user may view all alerts received by pressing button 1708. The user may transfer points (e.g., to another rewards ID, to another user of the site 170, etc.) by pressing button 1702.

The user may view and customize or edit preferences related to the account alerts by using screen 1800 of FIG. 18. The user may edit contact information for the user by pressing button 1802. The user may view category settings for user rewards by pressing button 1804. The user may edit how alerts are received by manipulating one or more of switches 1806 on the screen 1800. For instance, the user may choose whether to receive targeted offers, discounts, or seasonal reminders via alerts by toggling the switches 1806. The user may also edit how alerts are received by manipulating one or more of switches 1808 on the screen 1800. For instance, the user may choose whether to receive alerts related to new rewards statements, auctions, achieved point redemption goals, gifting transaction confirmations, and auto-redemption deposits via SMS messages by toggling the switches 1808. In the illustrated embodiment, the user automatically receives emails for each of the alerts related to the user account, but in other embodiments the user may be able to opt out of emails for these types of alerts.

Referring now to FIG. 19, screen 1902 may be displayed on the mobile device 110 when a code is generated as part of a transaction between the holder of the rewards account 137 and a merchant. Screen 1902 includes scannable code 1908 that may be generated for a merchant to scan. The code 1908 may be any type of scannable or otherwise readable code, as described herein. The code 1908 may be displayed by the mobile device 110 based on information provided by the account management computer system 130. When the code 1908 is generated and displayed on the mobile device 110, the account that will be used to pay the merchant is identified under the code 1908 at field 1906. Once the merchant has scanned the code 1908, the account holder may select close button 1912 to exit screen 1902 and/or end the transaction.

After scanning the code 1908, the merchant may transmit the code 1908 to the account management computer system 130, as previously described. The account management computer system 130 may then return account information (e.g., a credit card number, debit card number, etc.) to backend servers associated with the merchant computer system 150 to permit the transaction to be processed in the same manner as a conventional credit card or debit card transaction. As previously mentioned, stored value cards may also be used and code 1908 may represent a payment amount provided by the stored value card.

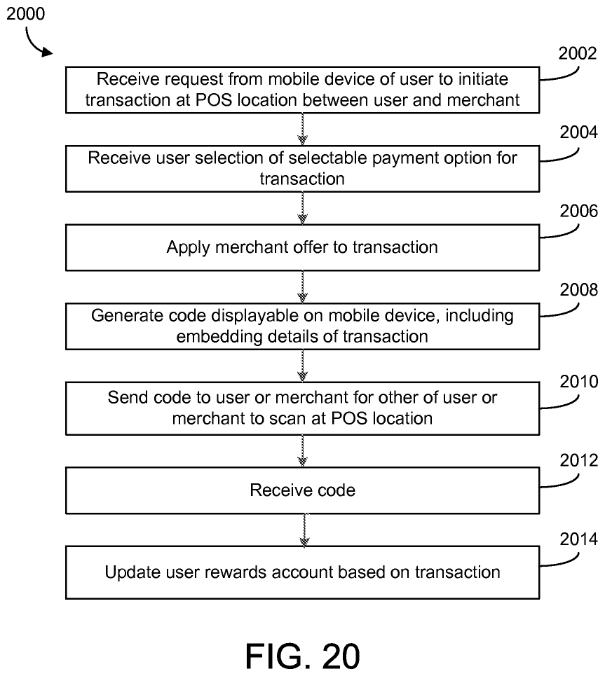

Referring now to FIG. 20, a process 2000 for facilitating a transaction at a point of sale location between a user (e.g., account holder) and a merchant is shown, according to an exemplary embodiment. The process 2000 may be implemented by the user rewards system 100 shown in FIG. 1, and more particularly the process 2000 may be implemented by using the account management computer system 130. At 2002, a request is received from a mobile device (e.g., mobile device 110) of a user (e.g., by account management computer system 130) to initiate a transaction at a point of sale location (e.g., using a point of sale device) between the user and a merchant (e.g., merchant computer system 150). At 2004, a user selection of a selectable payment option for the transaction is received from the user (e.g., by the account management computer system 130). The payment options may include an option to provide payment via a financial account of the user, including a checking account, a savings account, a credit card account, or an online payment account (e.g., PayPal, online banking account, etc.). The financial account may be held by the financial institution that holds the user rewards account 137, or may be a financial account held by a separate financial institution. The payment options may also include a value card (e.g., gift card) stored within the user rewards account 137 and eligible for use as payment in a transaction with the merchant. The value card may have been received in exchange for rewards points or otherwise stored within the account 137. The payment options may also include user rewards points, such as those received as part of a user loyalty program associated with an account of the user. For instance, the user may select to redeem rewards points in exchange for a cash value payable to the merchant.

At 2006, a merchant offer is applied to the transaction. The merchant offer may be selected by the user from a plurality of offers provided by the merchant. In an exemplary embodiment, the merchant offer is offered by the merchant in response to redemption of one or more user rewards by the user as part of a transaction. For instance, the user may redeem a merchant value card in exchange for goods and/or services in a transaction with the merchant. The merchant value card may be obtained by the user in exchange for user rewards points as part of a loyalty account. The merchant may then offer an activatable merchant offer that may be activated and applied to the current transaction. The merchant offer may include a discount on a payment amount of the transaction, a bonus points offer, an offer for free or discounted goods or services, or the like. The merchant offer may also be offered by the merchant prior to selection of a user rewards redemption, such as to entice the user to redeem rewards points in exchange for value cards or other payment methods useable in a transaction with the merchant (e.g., usable solely in a transaction with the merchant). The selectable merchant offers may be displayed on the mobile device 110 as via the mobile rewards site 170.

At 2008, a code (e.g., code 1908) is generated (e.g., by the account management computer system 130). Details related to the transaction may be embedded within the code as part of generating the code. The code is displayable on the mobile device 110. At 2010, the code is sent to one of the user at the mobile device 110 or the merchant at a merchant point of sale device (e.g., merchant computer system 150) for the other of the user or the merchant to scan at the point of sale location. Once the code is scanned, the code is received at block 2012 (e.g., from mobile device 110, from the point of sale device 150, etc.), such as by the account management computer system 130. At block 2016, a user account associated with the user is adjusted based on the transaction. For instance, if the user redeemed rewards points in exchange for a portion of the payment amount, the rewards point balance within the user rewards account 137 is reduced by an appropriate amount.

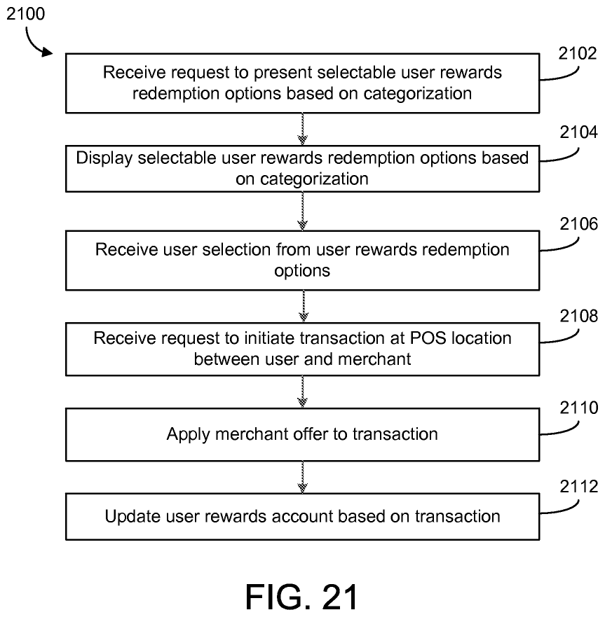

Referring now to FIG. 21, another process 2100 for facilitating a transaction between a user (e.g., account holder) and a merchant using a mobile device (e.g., mobile device 110) of the user and a point of sale device of the merchant is shown, according to an exemplary embodiment. The process 2100 may be implemented by the user rewards system 100 shown in FIG. 1, and more particularly the account management computer system 130 may be used to implement the process 2100. At block 2102, a request is received (e.g., by the account management computer system 130) to present selectable user rewards redemption options on the mobile device 110 based on categorization. For instance, the user may request the redemption options to be grouped based on an associated merchant, based on a type of goods or services provided, based on a location of the merchant, or based on another characteristic of the redemption option and/or the merchant.

At 2104, the selectable user rewards redemption options are displayed on the mobile device 110 based on a categorization of the redemption options. The redemption options may be displayed through the mobile rewards site 170 and available for selection within the user rewards account 137. The redemption options may include a value card (e.g., gift card) stored within the user rewards account 137 and eligible for use as payment in a transaction with the merchant. The value card may have been received in exchange for rewards points or otherwise stored within the account 137. The value card may also be purchased using cash or rewards points at the time of selection. The payment options may also include user rewards points, such as those received as part of a user loyalty program associated with an account of the user. As an example, the user may exchange user rewards points for a cash value available for use in a transaction with the merchant (e.g., merchant computer system 150). The user may also exchange the user rewards points in exchange for a value card for use in a transaction with the merchant. At 2106, a selection is received from the user rewards redemption options.

At 2108, a request to initiate a transaction between the user and the merchant at a point of sale location is received via the mobile device 110. For instance, the user may be at an in-store location of the merchant. The request may be sent by the user in order to provide payment to the merchant at a cash register, for instance. At 2110, a merchant offer is applied to the transaction. As described above, the merchant offer may be a discount on the current transaction, an offer for discounted merchandise, or an offer for additional user rewards available with the transaction. At 2112, the user rewards account 137 is updated based on the transaction.

The scope of this disclosure should be determined by the claims, their legal equivalents and the fact that it fully encompasses other embodiments which may become apparent to those skilled in the art. All structural, electrical and functional equivalents to the elements of the below-described disclosure that are known to those of ordinary skill in the art are expressly incorporated herein by reference and are intended to be encompassed by the present claims. A reference to an element in the singular is not intended to mean one and only one, unless explicitly so stated, but rather it should be construed to mean at least one. No claim element herein is to be construed under the provisions of 35 U.S.C. § 112, sixth paragraph, unless the element is expressly recited using the phrase “means for.” Furthermore, no element, component or method step in the present disclosure is intended to be dedicated to the public, regardless of whether the element, component or method step is explicitly recited in the claims.

The embodiments in the present disclosure have been described with reference to drawings. The drawings illustrate certain details of specific embodiments that implement the systems and methods and programs of the present disclosure. However, describing the embodiments with drawings should not be construed as imposing any limitations that may be present in the drawings. The present disclosure contemplates methods, systems and program products on any machine-readable media for accomplishing its operations. The embodiments of the present disclosure may be implemented using an existing computer processor, or by a special purpose computer processor incorporated for this or another purpose or by a hardwired system.

As noted above, embodiments within the scope of the present invention include program products comprising non-transitory machine-readable media for carrying or having machine-executable instructions or data structures stored thereon. Such machine-readable media may be any available media that may be accessed by a general purpose or special purpose computer or other machine with a processor. By way of example, such machine-readable media may comprise RAM, ROM, EPROM, EEPROM, CD-ROM or other optical disk storage, magnetic disk storage or other magnetic storage devices, or any other medium which may be used to carry or store desired program code in the form of machine-executable instructions or data structures and which may be accessed by a general purpose or special purpose computer or other machine with a processor. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments in the present disclosure have been described in the general context of method steps which may be implemented in one embodiment by a program product including machine-executable instructions, such as program code, for example, in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments in the present disclosure may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments in the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the disclosure might include one or more computers including a processor, a system memory or database, and a system bus that couples various system components including the system memory to the processor. The database or system memory may include read only memory (ROM) and random access memory (RAM). The database may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. User interfaces, as described herein, may include a computer with a monitor, a keyboard, a keypad, a mouse, a joystick or other input devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure. Such variations will depend on the software and hardware systems chosen and on designer choice. It is understood that all such variations are within the scope of the disclosure. Likewise, software and web implementations of the present invention could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the subject matter to the precise form disclosed, and modifications and variations are possible in light of the above teachings or may be acquired from practice of the subject matter disclosed herein. The embodiments were chosen and described in order to explain the principals of the disclosed subject matter and its practical application to enable one skilled in the art to utilize the disclosed subject matter in various embodiments and with various modifications as are suited to the particular use contemplated. Other substitutions, modifications, changes and omissions may be made in the design, operating conditions and arrangement of the embodiments without departing from the scope of the presently disclosed subject matter.

Throughout the specification, numerous advantages of the exemplary embodiments have been identified. It will be understood, of course, that it is possible to employ the teachings herein without necessarily achieving the same advantages. Additionally, although many features have been described in the context of a particular data processor, it will be appreciated that such features could also be implemented in the context of other hardware configurations.

While the exemplary embodiments illustrated in the figures and described above are presently preferred, it should be understood that these embodiments are offered by way of example only. Other embodiments may include, for example, structures with different data mapping or different data. The disclosed subject matter is not limited to a particular embodiment, but extends to various modifications, combinations, and permutations that nevertheless fall within the scope and spirit of the appended claims.

1. A computer-implemented method, comprising:
receiving a request from a mobile device of a user to initiate a transaction at a point of sale location between the user and a merchant;
receiving a user selection of a selectable payment option for the transaction, wherein the selectable payment option includes a user rewards redemption;
providing a merchant offer to the user as an activatable option via the mobile device, the merchant offer offered by the merchant in response to redemption of one or more user rewards by the user as part of the transaction;
receiving a selection of activation of the merchant offer from the user;
in response to the user selection, applying the merchant offer to the transaction;
generating, by a remote account management computer system, a code that is displayable on the mobile device, including embedding in the code one or more details related to the transaction and the merchant offer;
sending the code from the remote account management computer system to the mobile device for a merchant point of sale device to scan at the point of sale location;
receiving, by the remote account management computer system, an amended code from the merchant point of sale device, the amended code including further transaction details including authentication information or an additional merchant offer and generated by the merchant point of sale device after scanning the code; and
in response to receiving the amended code, updating a user rewards account associated with the user based on the transaction.

2. The method of claim 1, further comprising:
receiving authentication data from the mobile device; and
providing access to the user account based on the authentication data.

3. The method of claim 1, wherein the selectable payment option is one of a plurality of payment options for the transaction displayed via the mobile device.

4. The method of claim 1, wherein the user rewards redemption includes a redemption of rewards points associated with a loyalty account of the user.

5. The method of claim 1, wherein the user rewards redemption includes a merchant value card having a cash balance.

6. (canceled)

7. The method of claim 1, further comprising:
receiving the merchant offer from the merchant prior to providing the merchant offer to the user as an activatable option via the mobile device.

8. (canceled)

9. The method of claim 1, wherein the merchant offer is one of a plurality of activatable merchant offers provided to the user via the mobile device.

10. (canceled)

11. A computer system having a processor coupled to machine-readable storage media, the machine-readable storage media having instructions stored therein that configure the processor to:
receive a request from a mobile device of a user to initiate a transaction at a point of sale location between the user and a merchant;
receive a user selection of a selectable payment option for the transaction, wherein the selectable payment option includes a user rewards redemption;
provide a merchant offer to the user as an activatable option via the mobile device, the merchant offer offered by the merchant in response to redemption of one or more user rewards by the user as part of the transaction;
receive a selection of activation of the merchant offer from the user;
in response to the user selection, apply a merchant offer to the transaction;
generate a code that is displayable on the mobile device, including embedding in the code one or more details related to the transaction and the merchant offer;
send the code to the mobile device for a merchant point of sale device to scan at the point of sale location;
receive an amended code from the merchant point of sale device, the amended code including further transaction details including authentication information or an additional merchant offer and generated by the merchant point of sale device after scanning the code; and
in response to receiving the amended code, update a user rewards account associated with the user based on the transaction.

12. The system of claim 11, wherein the processor is further configured to:
receive authentication data from the mobile device; and
provide access to the user account based on the authentication data.

13. The system of claim 11, wherein the selectable payment option is one of a plurality of payment options for the transaction displayed via the mobile device.

14. The system of claim 11, wherein the user rewards redemption includes a redemption of rewards points associated with a user loyalty account.

15. The system of claim 11, wherein the user rewards redemption includes a merchant value card having a cash balance.

16. (canceled)

17. The system of claim 11, wherein the processor is further configured to:
receive the merchant offer from the merchant prior to providing the merchant offer to the user as an activatable option via the mobile device.

18. (canceled)

19. The system of claim 11, wherein the merchant offer is one of a plurality of merchant offers provided to the user via the mobile device.

20. (canceled)

21. A computer-implemented method, comprising:
receiving, via a mobile device of a user, a request to present one or more selectable user rewards redemption options based on a categorization;
displaying, via the mobile device, the one or more selectable user rewards redemption options based on the categorization;
receiving, via the mobile device, a user selection from the one or more user rewards redemption options;
receiving, via the mobile device, a request to initiate a transaction at a point of sale location between the user and a merchant, wherein the user selection includes a payment method for the transaction;
applying a merchant offer to the transaction; and
updating a user rewards account associated with the user based on the transaction.

22. The method of claim 21, further comprising:
receiving authentication data from the mobile device; and
providing access to the user account based on the authentication data.

23. The method of claim 21, further comprising:
generating a code that is displayable on the mobile device, including embedding in the code one or more details related to the transaction;
sending the code to one of the user at the mobile device or the merchant at a merchant point of sale device for the other of the user or the merchant to scan at the point of sale location; and
receiving the code from the user or the merchant prior to updating the user rewards account.

24. The method of claim 23, wherein generating the code includes embedding in the code the merchant offer.

25. The method of claim 21, further comprising:
displaying the merchant offer to the user as an activatable option via the mobile device; and
receiving a selection of activation of the merchant offer from the user, via the mobile device, prior to applying the merchant offer to the transaction.

26. The method of claim 25, wherein the merchant offer is one of a plurality of selectable offers displayed to the user via the mobile device.

27. The method of claim 21, wherein the merchant offer is based on the user selection.

28. The method of claim 21, wherein the categorization is based on a selection received from the user via the mobile device.

29. A computer system having a processor coupled to machine-readable storage media, the machine-readable storage media having instructions stored therein that configure the processor to:
receive a request from a mobile device of a user to initiate a transaction at a point of sale location between the user and a merchant;
receive a user selection of a selectable payment option for the transaction, wherein the selectable payment option includes a user rewards redemption;
provide a merchant offer to the user as an activatable option via the mobile device, the merchant offer offered by the merchant in response to redemption of one or more user rewards by the user as part of the transaction;
receive a selection of activation of the merchant offer from the user;
in response to the user selection, apply the merchant offer to the transaction;
generate a code including embedding in the code one or more details related to the transaction and the merchant offer;
send the code to the user at the mobile device for a merchant to non-optically scan at the point of sale location;
receive an amended code from the merchant point of sale device, the amended code including further transaction details including authentication information or an additional merchant offer and generated by the merchant point of sale device after scanning the code; and
in response to receiving the amended code, update a user rewards account associated with the user based on the transaction.

30. The system of claim 29, wherein the processor is further configured to:
receive authentication data from the mobile device; and
provide access to the user account based on the authentication data.

31. The system of claim 29, wherein the selectable payment option is one of a plurality of payment options for the transaction displayed via the mobile device.

32. The system of claim 29, wherein the user rewards redemption includes a redemption of rewards points associated with a user loyalty account.

33. The system of claim 29, wherein the user rewards redemption includes a merchant value card having a cash balance.

34. The system of claim 29, wherein the processor is further configured to:
receive the merchant offer from the merchant prior to providing the merchant offer to the user as an activatable option via the mobile device.

35. (canceled)

36. The system of claim 29, wherein the merchant offer is one of a plurality of merchant offers provided to the user via the mobile device.
